(19) United States
(12) Patent Application Publication
(10) Pub. No.: US 2016/0139753 A1
(43) Pub. Date: May 19, 2016

(54) INFORMATION PROCESSING APPARATUS AND METHOD FOR INFORMATION PROCESSING APPARATUS

(71) Applicant: CANON KABUSHIKI KAISHA, Tokyo (JP)

(72) Inventor: Masaaki Sato, Yokohama-shi (JP)

(21) Appl. No.: 14/938,171

(22) Filed: Nov. 11, 2015

(30) Foreign Application Priority Data
Nov. 14, 2014 (JP) 2014-232001

(51) Int. Cl. G06F 3/0483

(52) U.S. Cl. CPC G06F 3/0483

(57) ABSTRACT

An information processing apparatus has a web browser operating thereon. When intent information is specified via the web browser while a first site is being browsed using a first tab, the information processing apparatus stores information related to the first tab and displays, using a second tab, a second site corresponding to the specified intent information via the web browser. Until the second tab is closed, the web browser restricts an operation on the first site using the first tab related to the stored information.

### BACKGROUND OF THE INVENTION

1. Field of the Invention

The present invention relates to control of an information processing apparatus having a web browser operating thereon to enable browsing of web sites by using a plurality of tabs.

2. Description of the Related Art

An information processing apparatus such as a personal computer (PC) is known to be connected to a web server on a network and to display an operation screen provided by a web application on the web server, on a web browser included in the information processing apparatus.

In this case, the web browser of the information processing apparatus first transmits a request for an operation screen to the web application on the web server. In response to the request from the information processing apparatus, the web application transmits, to the information processing apparatus, HyperText Markup Language (HTML) data for displaying the operation screen on the web browser. The web browser of the information processing apparatus analyzes the received HTML data and displays the operation screen based on the description of the HTML data. When a user inputs an instruction via the operation screen displayed on the web browser, the web browser notifies the web server of the input instruction. When receiving the notification, the web application on the web server performs processing according to the input instruction.

Further, there has been considered a method that allows, in a case where there is a plurality of such web applications, a web application to call another web application by means of a Remote Procedure Call (RPC) so that they can cooperate with each other. This mode is a web application cooperation function represented by Web Intents (hereinafter referred to as an intent). Using an intent enables the user to directly call, from a web application, a service published by another web application, thereby improving user's convenience. Generally, when an intent is called, a new tab window (hereinafter referred to as a new tab) is displayed.

Due to restrictions on hardware resources of an information processing apparatus on which a web browser is installed, an upper limit is set on the number of a plurality of tab windows (hereinafter referred to as tabs) displayable on the web browser.

Japanese Patent Application Laid-Open No. 2011-39874 discusses a technique for hiding a caller tab in a case where the identifier (ID) of a caller application matches the ID of a called application in order to prevent the number of tabs displayed on the web browser from reaching the upper limit.

However, in a case where a new tab is displayed via an intent call, the ID of the caller web application differs from the ID of the called web application. Accordingly, the technique discussed in Japanese Patent Application Laid-Open No. 2011-39874 is not applicable to intents.

Conventionally, while a called tab is displayed, a user can easily switch an operation target to a caller tab to further call an intent. However, there has been a problem that repeatedly switching the operation target to the caller tab to call an intent increases the number of displayed tabs, reaching an upper limit on the number of displayable tabs on the web browser. This is undesirable in terms of usability.

### SUMMARY OF THE INVENTION

The present invention is directed to a technique for preventing the number of tabs displayed on a web browser from easily reaching the upper limit due to the tabs called via an intent, thus improving user's convenience.

According to an aspect of the present invention, an information processing apparatus having a web browser operating thereon to enable browsing of web sites by using a plurality of tabs includes a management unit configured to manage, in a storage device, intent information corresponding to a web application, a reception unit configured to receive specification of the intent information via the web browser, a storage unit configured to store, in a case where the intent information is specified via the web browser while a first site is being browsed using a first tab, information related to the first tab, and a display control unit configured to display, using a second tab, a second site corresponding to the specified intent information via the web browser. Until the second tab is closed, the web browser restricts an operation on the first site using the first tab related to the stored information.

Further features of the present invention will become apparent from the following description of exemplary embodiments with reference to the attached drawings.

### BRIEF DESCRIPTION OF THE DRAWINGS

FIG. 1 illustrates an overall configuration of an image processing system to which an information processing apparatus according to an exemplary embodiment of the present invention is applicable.

FIG. 2 illustrates a hardware configuration of a multifunctional peripheral (MFP).

FIG. 3 illustrates a software configuration of the MFP.

FIGS. 4A and 4B each illustrate an example of a tab transition information management table.

FIGS. 5A and 5B illustrate an example of a tab display mode management table and an example of an upper limit number management table, respectively.

FIG. 6 is a flowchart illustrating tab transition information registration processing.

FIG. 7 is a flowchart illustrating close button press processing.

FIG. 8 is a flowchart illustrating display mode switching processing.

FIG. 9 is a flowchart illustrating processing for checking whether the number of displayed tabs reaches an upper limit.

FIGS. 10A and 10B each illustrate an example of a received response.

FIG. 11 illustrates an example of a screen displayed in case 1 according to an application example 1.

FIG. 12 illustrates an example of an intent list.

FIG. 13 illustrates an example of a screen displayed in case 2 according to the application example 1.

FIG. 14 illustrates an example of a screen displayed in a case where Mode 2-1 is selected according to an application example 2.

FIG. 15 illustrates an example of a screen displayed in a case where Mode 2-2 is selected according to the application example 2.

FIG. 16 illustrates an example of a screen displayed in a case where Mode 2-3 is selected according to the application example 2.

FIG. 17 illustrates an example of a screen displayed in a case according to an application example 3.

FIG. 18 illustrates an example of an error message.

FIG. 19 illustrates an example of information about connection destinations available as services.

### DESCRIPTION OF THE EMBODIMENTS

An exemplary embodiment of the present invention will be described below with reference to the accompanying drawings.

The exemplary embodiment described below does not limit the present invention within the scope of the appended claims. Not all the combinations of the features described in the exemplary embodiment are indispensable to the solutions for the present invention.

An image processing apparatus according to an exemplary embodiment of the present invention will be described below.

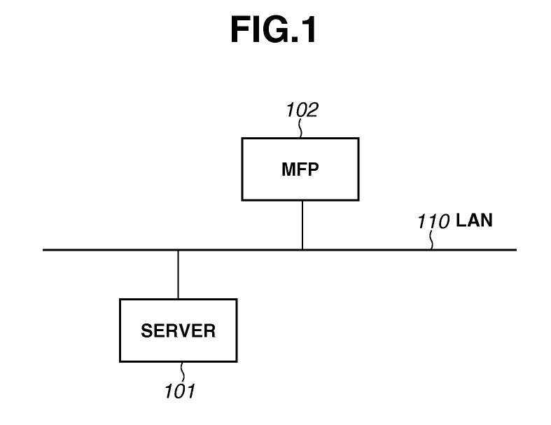

FIG. 1 illustrates an overall configuration of an image processing system to which an information processing apparatus according to the present exemplary embodiment is applicable.

Referring to FIG. 1, a multifunction peripheral (MFP) 102 is an example of an information processing apparatus according to the present exemplary embodiment.

A server 101 and the MFP 102 are connected via a local area network (LAN) 110 so that they can communicate with each other. The server 101 and the MFP 102 may be connected via a (wired or wireless) network other than the LAN 110 such as the Internet.

The present exemplary embodiment will be described below using the MFP 102 as an example of an information processing apparatus. However, the present exemplary embodiment is applicable to any apparatus having a web browser operating thereon to enable browsing of web sites by using a plurality of tabs. For example, the present exemplary embodiment is applicable to a PC, a tablet terminal, a mobile phone, a smartphone, a car navigation system, a television, and a networked home appliance having the above-described web browser operating thereon.

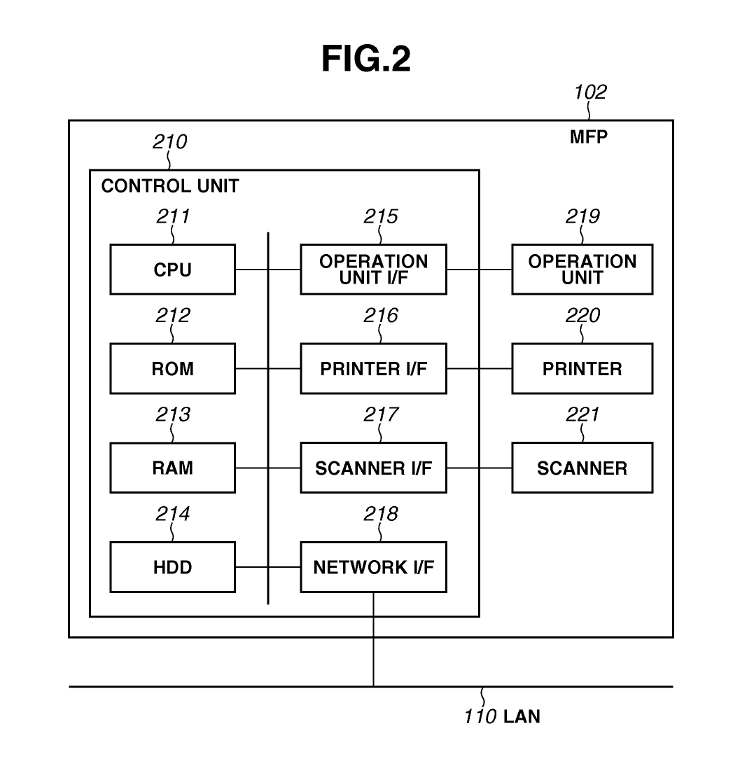

FIG. 2 is a block diagram illustrating a hardware configuration of the MFP 102.

A control unit 210 including a central processing unit (CPU) 211 controls the entire operation of the MFP 102. The CPU 211 reads a control program stored in a read only memory (ROM) 212 and then executes it to perform various types of control processing such as reading control and transmission control. A random access memory (RAM) 213 is used as a main memory and a temporary storage area such as a work area for the CPU 211. A hard disk drive (HDD) 214 stores image data and various programs. The MFP 102 may be provided with any other storage device such as a solid state drive (SSD).

An operation unit interface (I/F) 215 connects an operation unit 219 and the control unit 210. The operation unit 219 is provided with a liquid crystal display (LCD) unit having a touch panel function, and a keyboard.

A printer I/F 216 connects a printer 220 and the control unit 210. The image data to be printed by the printer 220 is transferred from the control unit 210 to the printer 220 via the printer I/F 216, and is printed on a recording sheet by the printer 220.

A scanner I/F 217 connects a scanner 221 and the control unit 210. The scanner 221 reads an image on a document, generates image data, and inputs the generated image data to the control unit 210 via the scanner I/F 217.

A network I/F 218 connects the control unit 210 (MFP 102) to the LAN 110. The network I/F 218 communicates with an external apparatus (e.g. the server 101) on the LAN 110 to transmit image data, for example.

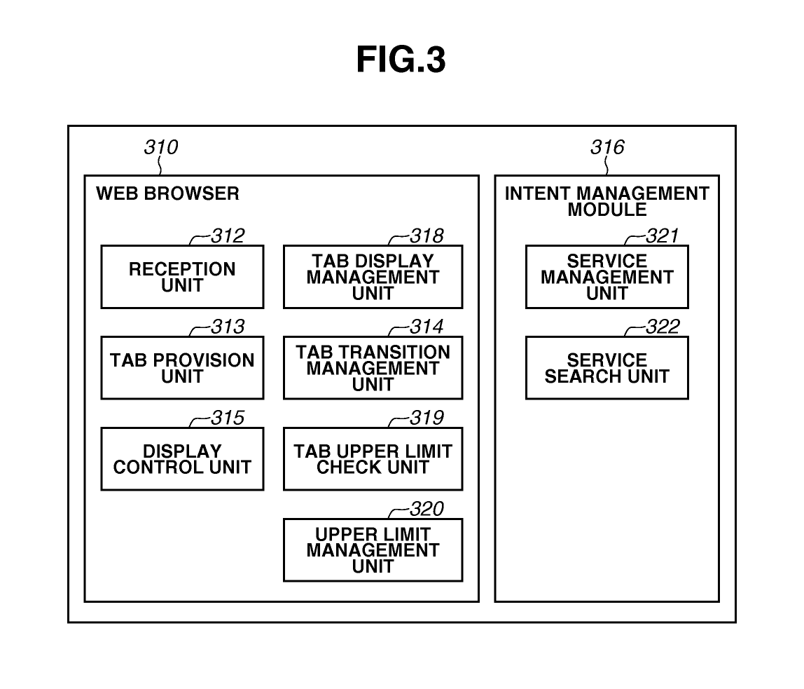

FIG. 3 illustrates a software configuration which is implemented when the CPU 211 executes each control program stored in the ROM 212 of the MFP 102.

FIG. 3 illustrates a web browser 310 and an intent management module 316.

A configuration of the web browser 310 will be described below.

A reception unit 312 recognizes a response received from the server 101, analyzes the recognized response, and provides a result of the analysis to a tab provision unit 313.

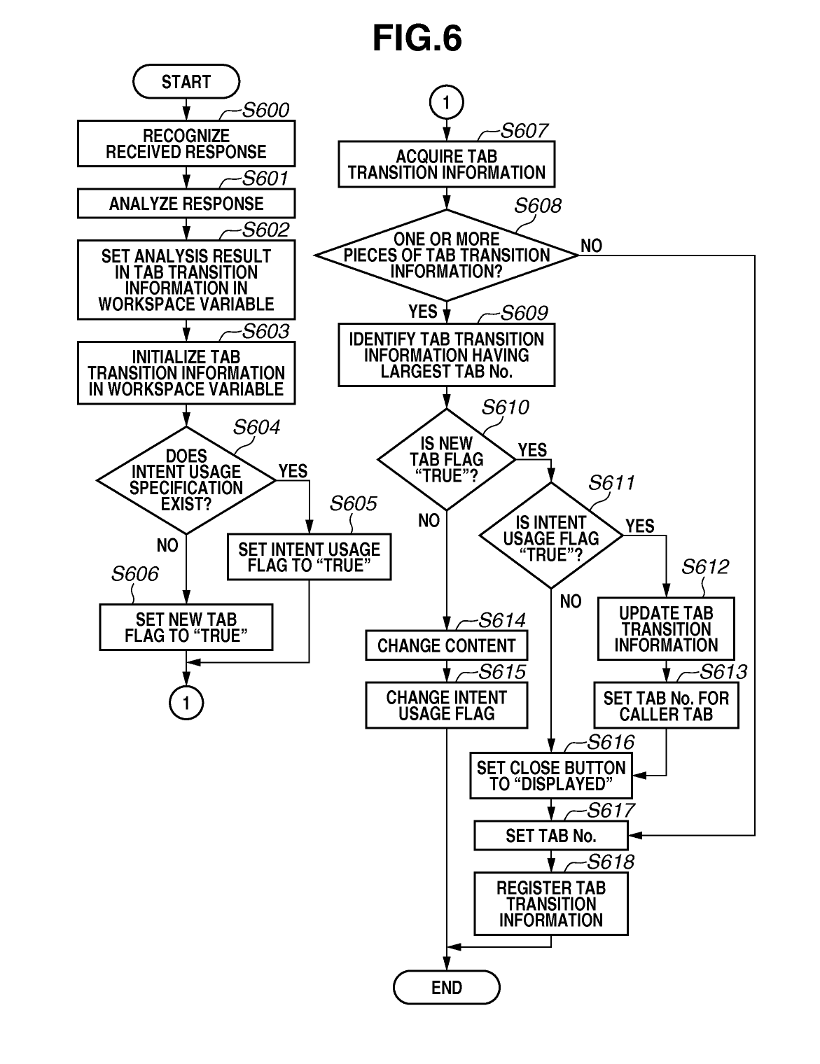

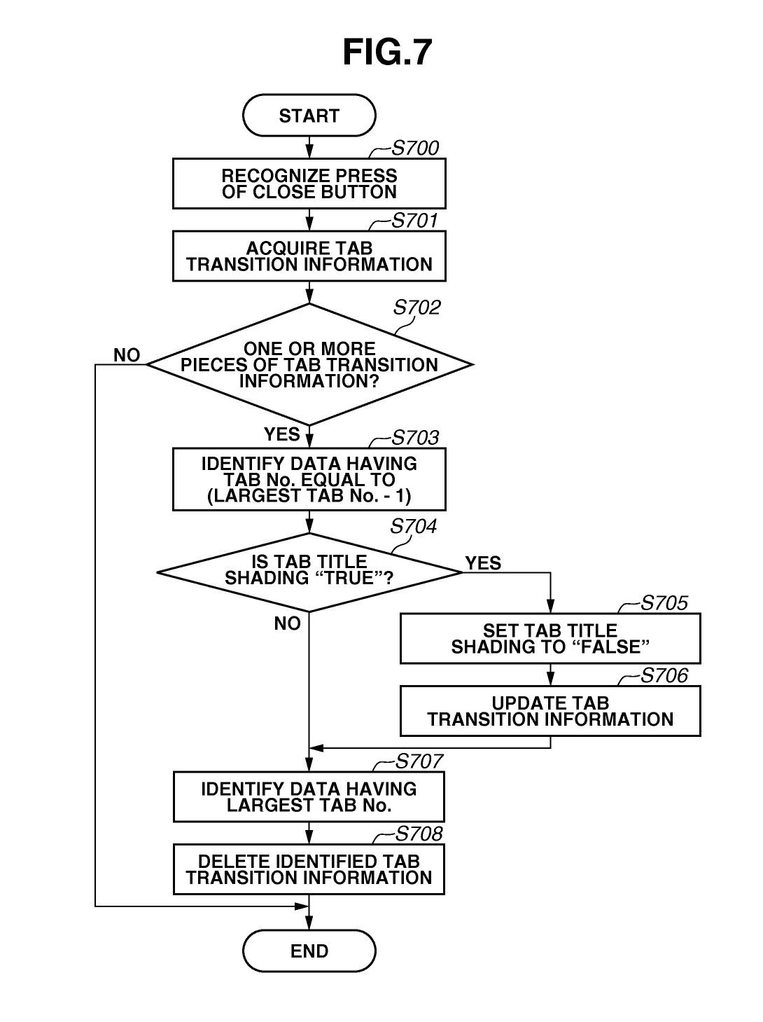

The tab provision unit 313 registers the response provided from the reception unit 312 to a tab transition management unit 314 (this processing is referred to as tab transition information registration processing as illustrated in FIG. 6 (described below)), and requests a display control unit 315 to display the registered tab transition information. The tab provision unit 313 further recognizes a press of a tab close button via the display control unit 315, updates the tab transition information of the tab transition management unit 314 (this processing is referred to as close button press processing as illustrated in FIG. 7 (described below)), and provides the updated tab transition information to the display control unit 315. Before providing the tab transition information to the display control unit 315, the tab provision unit 313 checks the display mode settings managed by a tab display management unit 318, and provides the tab transition information, in which the contents of the display mode settings have been reflected, to the display control unit 315.

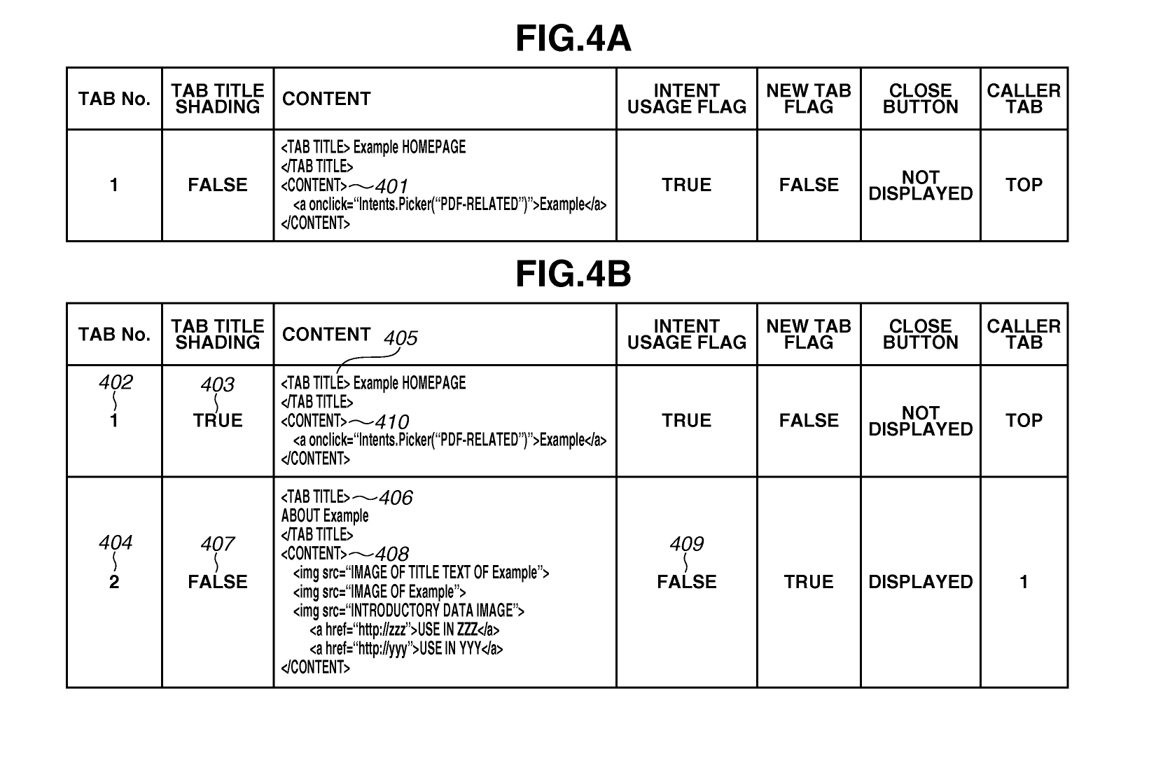

The tab transition management unit 314 stores and manages, in a tab transition information management table, the display mode for each tab number, the content to be displayed on each tab, and the tab number value of a caller tab, as illustrated in FIGS. 4A and 4B.

FIGS. 4A and 4B each illustrate an example of the tab transition information management table stored by the tab transition management unit 314. This information is assumed to be stored in the HDD 214.

As illustrated in FIGS. 4A and 4B, in the tab transition information management table, information such as “Tab No.”, “Tab Title Shading”, “Content”, “Intent Usage Flag”, “New Tab Flag”, “Close Button”, and “Caller Tab” are stored and managed.

The “Tab No.” column is used to uniquely identify the tab transition information. The “Tab Title Shading” column is used to indicate whether to shade the tab title of the tab. The tab title functions as an instruction portion for issuing an instructing for switching the operation target tab. With the tab title shading specified, the tab title is displayed in a mode where the instruction cannot be issued. Therefore, via a tab title in this mode, an instruction for switching the operation target tab cannot be received.

The “Content” column is used to indicate information of the content to be displayed on the tab. The “Intent Usage Flag” column is used to indicate whether a definition for calling intent is included in the content to be displayed on the tab. The “New Tab Flag” column is used to indicate whether the tab has been opened as a new tab. The “Close Button” column is used to indicate whether to display a close button on the tab. The “Caller Tab” column is used to indicate the tab number of a tab that has called the tab.

FIG. 3 will be described again below.

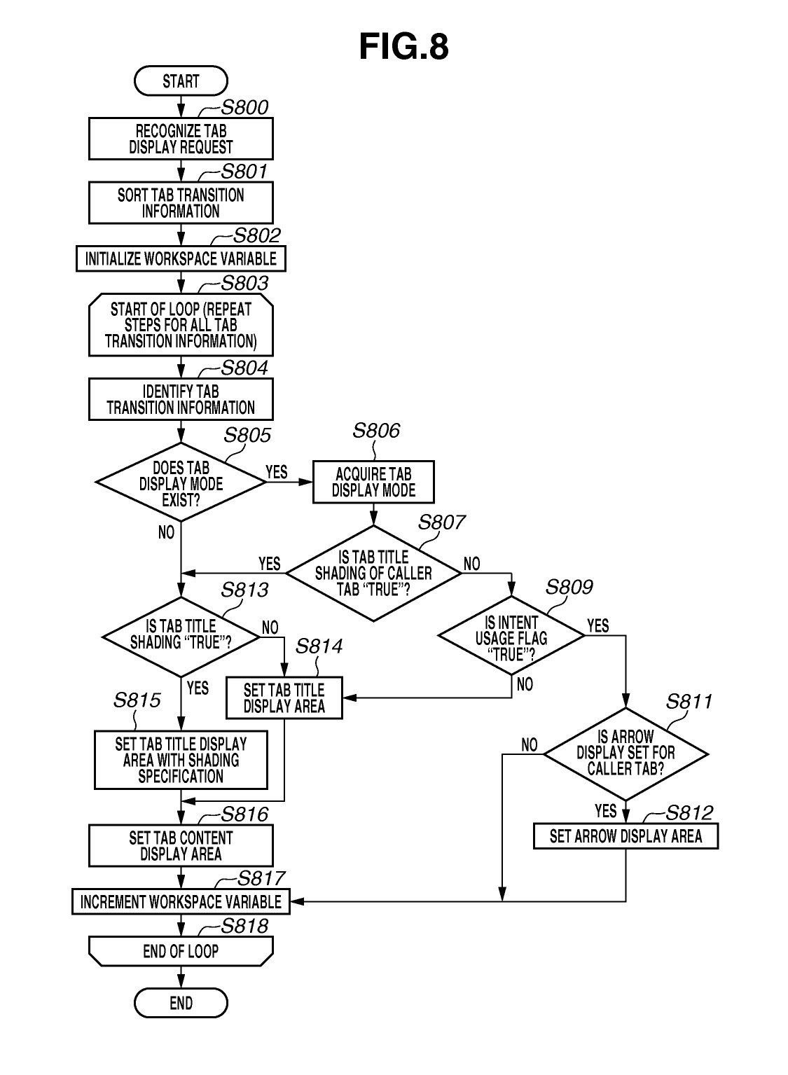

When receiving from the tab provision unit 313 a request for displaying the tab transition information, the display control unit 315 performs control to display the tab transition information managed by the tab transition management unit 314 on a display unit such as the operation unit 219 (this processing is referred to as display mode switching processing as illustrated in FIG. 8 (described below)). The display control unit 315 further performs control to display, on a display unit such as the operation unit 219, information about a list of available intents provided by a service management unit 321 of the intent management module 316, and an error message provided by a tab upper limit check unit 319.

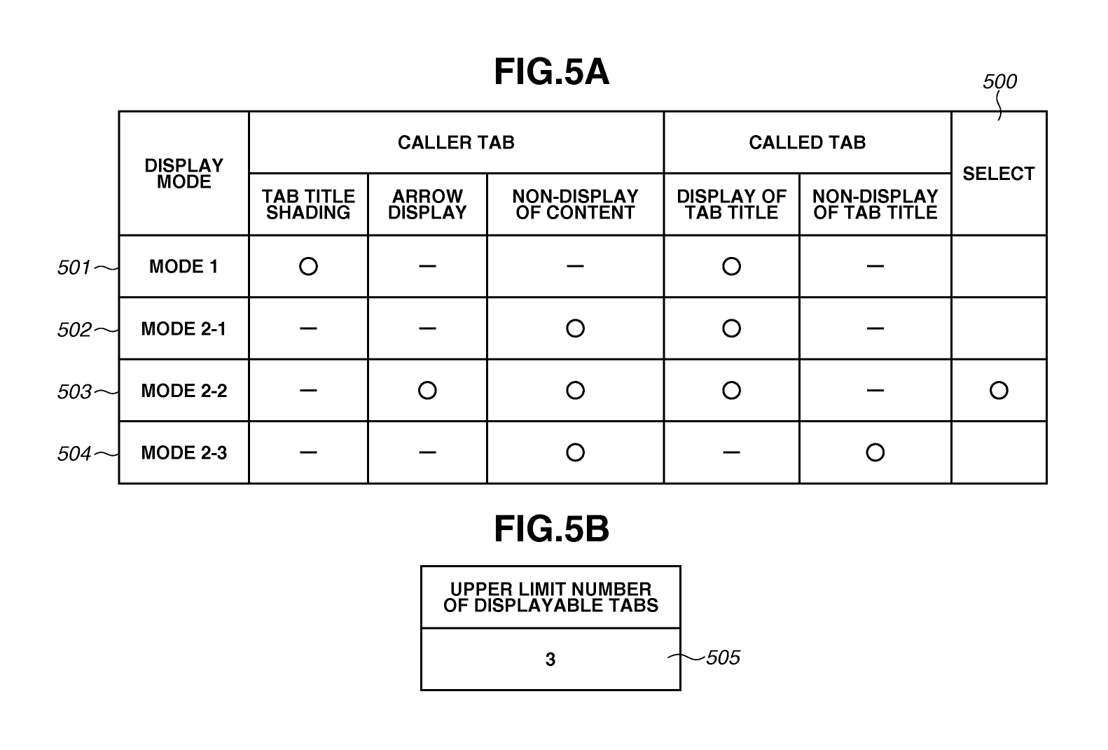

The tab display management unit 318 stores and manages the display mode setting values for the caller and called tabs in a tab display mode management table as illustrated in FIG. 5A. These setting values are assumed to be preset by an administrator of the MFP 102 via the operation unit 219 or by using a PC connected with the MFP 102 via the LAN 110.

FIG. 5A illustrates an example of the tab display mode management table stored by the tab display management unit 318. This information is assumed to be stored in the HDD 214.

As illustrated in FIG. 5A, in the tab display mode management table, setting information such as “Display Mode”, “Caller Tab”, “Called Tab”, and “Select” is stored and managed.

The “Display Mode” column is used to uniquely identify a display mode. The “Caller Tab” column is used to indicate display mode setting information of a caller tab, including setting information such as “Tab Title Shading”, “Arrow Display”, and “Non-Display of Content”. The “Tab Title Shading” column is used to indicate whether to display the tab title of the caller tab with shading. The “Arrow Display” column is used to indicate whether to display an arrow-shaped button for returning to the caller tab. The “Non-Display of Content” column is used to indicate whether to display the content of the caller tab.

The “Called Tab” column is used to indicate display mode setting information of a called tab, including setting information such as “Display of Tab Title” and “Non-Display of Tab Title”. The “Display of Tab Title” column and the “Non-Display of Tab Title” column are used to indicate whether to display the tab title of the called tab.

The “Select” column is used to indicate which display mode is selected.

FIG. 3 will be described again below.

When the service management unit 321 of the intent management module 316 requests the tab upper limit check unit 319 to check the number of a plurality of tabs currently being displayed, the tab upper limit check unit 319 checks whether the number of a plurality of tabs, which is managed by the tab transition management unit 314 and is currently being displayed, has reached the upper limit. When the number of a plurality of tabs currently being displayed has reached the upper limit, the tab upper limit check unit 319 provides, to the display control unit 315, an error message indicating that the upper limit is reached.

An upper limit management unit 320 stores and manages, in an upper limit number management table as illustrated in FIG. 5B, the upper limit number of tabs to be displayed via the display control unit 315, and provides the information about the upper limit number.

FIG. 5B illustrates an example of the upper limit number management table for a plurality of displayable tabs, which is stored by the upper limit management unit 320. This information is assumed to be stored in the HDD 214.

A configuration of the intent management module 316 will be described below.

The intent management module 316 enables cooperation between web applications by using the mechanism of web intents.

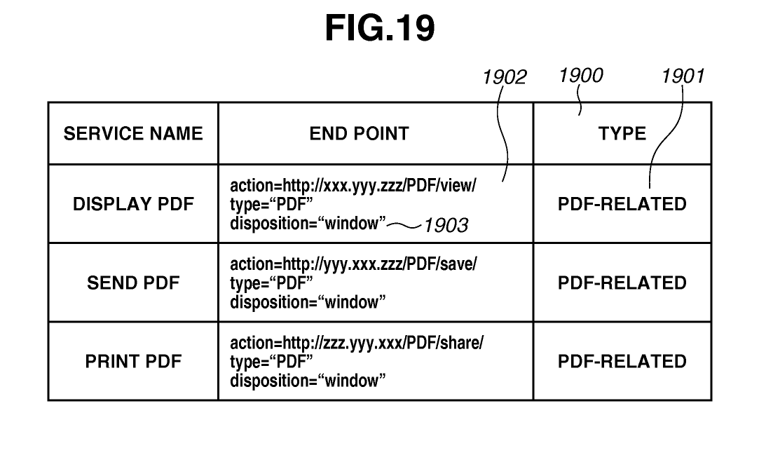

The service management unit 321 manages information of a plurality of connection destinations available as services, as illustrated in FIG. 19. More specifically, the service management unit 321 manages intent information corresponding to web applications. Further, the service management unit 321 recognizes the reception of a request for acquiring a list of intents that are available when a particular type (a file type such as “PDF-related” (a type 1901) is specified. The service management unit 321 calls a service search unit 322 to acquire a list of intents to be managed, and requests the display control unit 315 of the web browser 310 to display the result of the call.

FIG. 19 illustrates an example of information about connection destinations available as services, which is managed by the service management unit 321.

As illustrated in FIG. 19, the service management unit 321 stores and manages information such as “Service Name”, “End Point”, and “Type” as information of connection destinations available as services. This information is assumed to be stored in the HDD 214.

FIG. 3 will be described again below.

When a particular type is specified, the service search unit 322 performs a narrow search for data corresponding to “Type” (1900 illustrated in FIG. 19) in the service management unit 321, and returns the search result to the service management unit 321.

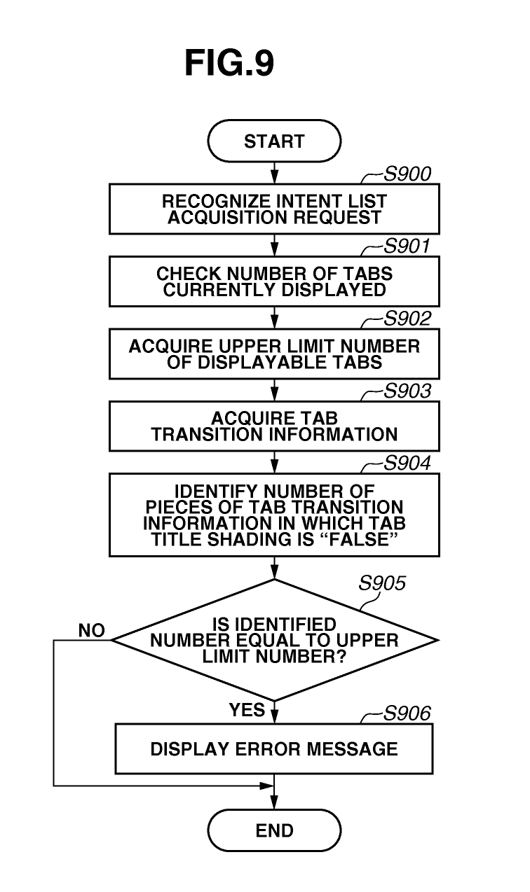

Before acquiring the list from the service search unit 322, the service management unit 321 calls a request for asking the tab upper limit check unit 319 of the web browser 310 to check the number of tabs currently being displayed (which is processing for checking whether the number of displayed tabs reaches the upper limit, as illustrated in FIG. 9 (described below)). When the number of a plurality of tabs currently being displayed does not exceed the upper limit, the service management unit 321 continues the processing.

Next, the tab transition information registration processing to be performed by the MFP 102 according to the present exemplary embodiment will be described with reference to FIG. 6.

FIG. 6 is a flowchart illustrating the tab transition information registration processing to be performed by the MFP 102 according to the present exemplary embodiment. Each operation of the flowchart illustrated in FIG. 6 is implemented when the CPU 211 of the MFP 102 reads a control program stored in the ROM 212 and then executes it. In the flowchart, reference numerals with the prefix ‘S’ denote steps.

In step S600, the reception unit 312 recognizes a response received from the server 101, and then the processing proceeds to step S601.

In step S601, the reception unit 312 analyzes the received response recognized in step S600, and provides the content of the analysis result to the tab provision unit 313.

In step S602, the tab provision unit 313 stores information of the content of the analysis result provided by the reception unit 312 in step S601, in the content of tab transition information in a workspace variable allocated in the RAM 213.

In step S603, the tab provision unit 313 performs initialization processing on the tab transition information in the workspace variable. In the initialization processing, the tab provision unit 313 sets the intent usage flag to “false”, the new tab flag to “false”, the tab title shading to “false”, the close button to “not displayed”, and the caller tab to “top” in the tab transition information in the workspace variable.

In step S604, the tab provision unit 313 determines whether a definition for calling intent is included in the content of the tab transition information in the workspace variable. For example, the content illustrated in FIG. 4A includes a definition for calling intent “Intents.Picker (“PDF-related”)” as the action to be taken in response to a click.

When the tab provision unit 313 determines that the definition is included in the content (YES in step S604), the processing proceeds to step S605.

In step S605, the tab provision unit 313 sets the intent usage flag of the tab transition information in the workspace variable to “true”, and the processing proceeds to step S607.

On the other hand, when the tab provision unit 313 determines that the definition is not included in the content (NO in step S604), the processing proceeds to step S606.

In step S606, the tab provision unit 313 sets the new tab flag of the tab transition information in the workspace variable to “true”, and the processing proceeds to step S607.

In step S607, the tab provision unit 313 acquires all pieces of tab transition information managed by the tab transition management unit 314.

In step S608, the tab provision unit 313 determines whether one or more pieces of tab transition information are acquired in step S607.

When the tab provision unit 313 determines that one or more pieces of tab transition information are not acquired, i.e., no piece of tab transition information is acquired (NO in step S608), the processing proceeds to step S617.

In step S617, the tab provision unit 313 sets the tab number of tab transition information in the workspace variable to a value equal to the total number of pieces of tab transition information acquired in step S607 plus 1.

In step S618, the tab provision unit 313 requests the tab transition management unit 314 to register the tab transition information of the workspace variable (e.g. information as illustrated in FIG. 4A). Then, the processing exits this flowchart.

On the other hand, when the tab provision unit 313 determines that one or more pieces of tab transition information are acquired in step S607 (YES in step S608), the processing proceeds to step S609. For example, when the tab transition information illustrated in FIG. 4A is acquired, the tab provision unit 313 determines that one piece of tab transition information is acquired (YES in step S608), and the processing proceeds to step S609.

In step S609, the tab provision unit 313 identifies the tab transition information having the largest tab number, in the tab transition information acquired in step S607. For example, when the tab transition information illustrated in FIG. 4A is acquired, the tab provision unit 313 identifies the tab transition information of “Tab No. 1” as the tab transition information having the largest tab number.

In step S610, the tab provision unit 313 determines whether the new tab flag of the tab transition information in the workspace variable is set to “true”

When the tab provision unit 313 determines that the new tab flag of the tab transition information in the workspace variable is set to “true” (YES in step S610), the processing proceeds to step S611.

In step S611, the tab provision unit 313 determines whether the intent usage flag of the tab transition information having the largest tab number identified in step S609 is set to “true” For example, when the tab transition information of “Tab No. 1” illustrated in FIG. 4A is identified in step S609, the intent usage flag is determined to be “true.”

When the tab provision unit 313 determines that the intent usage flag is set to “true” (YES in step S611), the processing proceeds to step S612.

In step S612, the tab provision unit 313 sets the tab title shading of the tab transition information having the largest tab number identified in step S609 to “true”. Further, the tab provision unit 313 requests the tab transition management unit 314 to update the tab transition information having the largest tab number. For example, the tab transition information of “Tab No. 1” illustrated in FIG. 4A is updated to the tab transition information of “Tab No. 1” illustrated in FIG. 4B.

In step S613, the tab provision unit 313 sets the caller tab of the tab transition information in the workspace variable to the tab number of the tab transition information having the largest tab number identified in step S609, and the processing proceeds to step S616.

On the other hand, when the tab provision unit 313 determines that the intent usage flag of the tab transition information having the largest tab number identified in step S609 is set to not “true” (i.e. “false”) (NO in step S611), the processing proceeds to step S616.

In step S616, the tab provision unit 313 sets the close button of the tab transition information in the workspace variable to “displayed”, and the processing proceeds to step S617.

In step S617, the tab provision unit 313 sets the tab number of the tab transition information in the workspace variable to a value equal to the total number of pieces of tab transition information acquired in step S607 plus 1.

In step S618, the tab provision unit 313 requests the tab transition management unit 314 to register the tab transition information of the workspace variable. For example, the tab provision unit 313 requests the tab transition management unit 314 to register the tab transition information of “Tab No. 2” illustrated in FIG. 4B. When the tab provision unit 313 completes the processing in step S618, the processing exits this flowchart.

On the other hand, when the tab provision unit 313 determines that the new tab flag of the tab transition information in the workspace variable is set to not “true” (i.e. “false”) (NO in step S610), the processing proceeds to step S614.

In step S614, the tab provision unit 313 sets the content of the tab transition information in the workspace variable, in the content of the tab transition information having the largest tab number identified in step S609.

In step S615, the tab provision unit 313 sets the intent usage flag of the tab transition information in the workspace variable, in the intent usage flag of the tab transition information having the largest tab number identified in step S609. Further, the tab provision unit 313 requests the tab transition management unit 314 to update the tab transition information having the largest tab number identified in step S609, and the processing exits this flowchart.

When the tab provision unit 313 completes the tab transition information registration processing as illustrated in FIG. 6, the tab provision unit 313 checks the display mode settings managed by the tab display management unit 318, reflects the display mode settings (e.g. the setting values illustrated in FIG. 5A) in the registered tab transition information, and requests the display control unit 315 to display the tab transition information in which the display mode settings have been reflected. In response to this request, the display control unit 315 performs display mode switching processing as illustrated in FIG. 8 (described below).

Next, the close button press processing to be performed by the MFP 102 according to the present exemplary embodiment will be described with reference to FIG. 7.

FIG. 7 is a flowchart illustrating the close button press processing to be performed by the MFP 102 according to the present exemplary embodiment. Each operation of the flowchart illustrated in FIG. 7 is implemented when the CPU 211 of the MFP 102 reads a control program stored in the ROM 212 and then executes it. In the flowchart, reference numerals with the prefix ‘S’ denote steps.

In step S700, the tab provision unit 313 recognizes a press of a close button on a tab via the display control unit 315, and the processing proceeds to step S701.

In step S701, the tab provision unit 313 acquires all pieces of tab transition information managed by the tab transition management unit 314.

In step S702, the tab provision unit 313 determines whether one or more pieces of tab transition information are acquired in step S701.

When the tab provision unit 313 determines that one or more pieces of tab transition information are not acquired, i.e., no piece of tab transition information is acquired (NO in step S702), the processing exits this flowchart.

On the other hand, when the tab provision unit 313 determines that one or more pieces of tab transition information are acquired (YES in step S702), the processing proceeds to step S703. For example, when the tab transition information illustrated in FIG. 4B is acquired, the tab provision unit 313 determines that two pieces of tab transition information are acquired (YES in step S702), and the processing proceeds to step S703.

In step S703, the tab provision unit 313 identifies the tab transition information having a tab number equal to “the largest tab number −1”, in the tab transition information acquired in step S701. Further, the tab provision unit 313 stores the identified tab transition information in the tab transition information in the workspace variable. For example, when the tab transition information illustrated in FIG. 4B is acquired, the tab transition information of “Tab No. 1” is stored.

In step S704, the tab provision unit 313 determines whether the tab title shading of the tab transition information in the workspace variable is set to “true”

When the tab provision unit 313 determines that the tab title shading is set to “true” (YES in step S704), the processing proceeds to step S705. For example, when the tab title shading of the tab transition information of “Tab No. 1” illustrated in FIG. 4B is set to “true” (YES in step S704), the processing proceeds to step S705.

In step S705, the tab provision unit 313 sets the tab title shading of the tab transition information in the workspace variable to “false”.

In step S706, the tab provision unit 313 requests the tab transition management unit 314 to update the tab transition information in the workspace variable, and the processing proceeds to step S707.

On the other hand, when the tab provision unit 313 determines that the tab title shading of the tab transition information in the workspace variable is set to not “true” (i.e. “false”) (NO in step S704), the processing proceeds to step S707.

In step S707, the tab provision unit 313 identifies the tab transition information having the largest tab number, in the tab transition information acquired in step S701.

In step S708, the tab provision unit 313 requests the tab transition management unit 314 to delete the tab transition information identified in step S707. For example, when the tab transition information illustrated in FIG. 4B is acquired in step S701, the information is updated to the tab transition information as illustrated in FIG. 4A in response to the update requested in step S708. When the tab provision unit 313 completes the processing in step S708, the processing exits this flowchart.

When the tab provision unit 313 completes the close button press processing as illustrated in FIG. 7, the tab provision unit 313 checks the display mode settings managed by the tab display management unit 318, reflects the display mode settings (e.g. the setting values illustrated in FIG. 5A) in the registered tab transition information, and requests the display control unit 315 to display the tab transition information in which the display mode settings have been reflected. In response to this request, the display control unit 315 performs display mode switching processing as illustrated in FIG. 8 (described below).

When receiving from the tab provision unit 313 a request for displaying the tab transition information, the display control unit 315 performs control to display, on a display unit such as the operation unit 219, the tab transition information managed by the tab transition management unit 314 (this processing is referred to as display mode switching processing).

Next, the display mode switching processing to be performed by the MFP 102 according to the present exemplary embodiment will be described with reference to FIG. 8.

FIG. 8 is a flowchart illustrating the display mode switching processing to be performed by the MFP 102 according to the present exemplary embodiment. Each operation of the flowchart illustrated in FIG. 8 is implemented when the CPU 211 of the MFP 102 reads a control program stored in the ROM 212 and then executes it. In the flowchart, reference numerals with the prefix ‘S’ denote steps.

In step S800, the display control unit 315 recognizes a request from the tab provision unit 313 for display of the tab transition information, and acquires all pieces of tab transition information managed by the tab transition management unit 314. For example, tab transition information as illustrated in FIG. 4B is acquired.

In step S801, the display control unit 315 sorts the tab transition information acquired in step S800 in ascending order of tab number.

In step S802, the display control unit 315 initializes the workspace variable N allocated in the RAM 213 to “1”. In steps S803 to S818, the display control unit 315 performs control so that the processing in steps S804 to S817 is performed for each of the pieces of tab transition information acquired in step S800.

In step S804, the display control unit 315 first identifies the Nth tab transition information among the tab transition information sorted in step S801 (hereinafter referred to as specific tab transition information).

In step S805, the display control unit 315 determines whether tab display mode setting values exist in the tab display mode management table of the tab display management unit 318.

When the display control unit 315 determines that tab display mode setting values exist in the tab display mode management table (YES in step S805), the processing proceeds to step S806.

On the other hand, when the display control unit 315 determines that tab display mode setting values do not exist in the tab display mode management table (NO in step S805), the processing proceeds to step S813.

In step S806, the display control unit 315 acquires the display mode setting values selected in the tab display mode management table of the tab display management unit 318.

In step S807, the display control unit 315 determines whether the tab title shading of the caller tab in the display mode setting values acquired in step S806 is set to “true” (O).

When the display control unit 315 determines that the tab title shading of the caller tab is set to “true” (O) (YES in step S807), the processing proceeds to step S813. For example, when Mode 1 (a display mode 501) illustrated in FIG. 5A is selected (YES in step S807), the processing proceeds to step S813.

In step S813, the display control unit 315 determines whether the tab title shading is set to “true” in the specific tab transition information.

When the display control unit 315 determines that the tab title shading is set to not “true” (i.e. “false”) in the specific tab transition information (NO in step S813), the processing proceeds to step S814. For example, when the tab transition information illustrated in FIG. 4B is acquired in step S800 and the workspace variable N is 2 (NO in step S813), the processing proceeds to step S814.

In step S814, the display control unit 315 sets the tab title of the specific tab transition information in the Nth tab title display area, and the processing proceeds to step S816. When the information to be displayed is set in the display area, the information is displayed on the display unit of the operation unit 219.

On the other hand, when the display control unit 315 determines that the tab title shading is set to “true” in the specific tab transition information (YES in step S813), the processing proceeds to step S815. For example, when the tab transition information illustrated in FIG. 4B is acquired in step S800 and the workspace variable N is 1 (YES in step S183), the processing proceeds to step S815.

In step S815, the display control unit 315 sets the tab title of the specific tab transition information in the Nth tab title display area with the tab title shading specified, and the processing proceeds to step S816.

When only one piece of tab transition information is acquired in step S800, the tab title display processing illustrated in steps S813 to S815 may be omitted.

Although not illustrated in FIG. 8, when the close button is set to “displayed” in the specific tab transition information, the display control unit 315 performs setting to display a close button in an area to the right of the title area.

In step S816, the display control unit 315 sets the content of the specific tab transition information in the Nth tab display area, and the processing proceeds to step S817.

In step S817, the display control unit 315 increments the workspace variable N by 1.

On the other hand, when the display control unit 315 determines that the tab title shading of the caller tab in the display mode setting values acquired in step S806 is set to not “true” (O) (NO in step S807), the processing proceeds to step S809. For example, when Mode 2-1 (a display mode 502), Mode 2-2 (a display mode 503), or Mode 2-3 (a display mode 504) illustrated in FIG. 5A is selected (NO in step S807), the processing proceeds to step S809.

In step S809, the display control unit 315 determines whether the intent usage flag is set to “true” in the specific tab transition information.

In step S809, when the display control unit 315 determines that the intent usage flag is set to “true” in the specific tab transition information (YES in step S809), the processing proceeds to step S811. For example, when the tab transition information illustrated in FIG. 4B is acquired in step S800 and the workspace variable N is 1 (YES in step S809), the processing proceeds to step S811.

In step S811, the display control unit 315 determines whether the arrow display is set for the caller tab in the display mode setting values acquired in step S806.

When the display control unit 315 determines that the arrow display is set for the caller tab (YES in step S811), the processing proceeds to step S812. For example, when Mode 2-2 (the display mode 503) illustrated in FIG. 5A is selected (YES in step S811), the processing proceeds to step S812.

In step S812, the display control unit 315 sets, in an arrow display area, specification for displaying the content of the caller tab of the specific tab transition information in response to a press of an arrow. Then, in step S817, the display control unit 315 increments the workspace variable N by 1.

On the other hand, when the arrow display is not set for the caller tab in the display mode setting values acquired in step S806 (NO in step S811), then in step S817, the display control unit 315 increments the workspace variable N by 1. For example, when Mode 2-1 (the display mode 502) or Mode 2-3 (the display mode 504) illustrated in FIG. 5A is selected (NO in step S811), the processing proceeds to step S817.

When the display control unit 315 determines that the intent usage flag is set to not “true” (i.e. “false”) in the specific tab transition information (NO in step S809), the processing proceeds to step S814. For example, when the tab transition information illustrated in FIG. 4B is acquired in step S800 and the workspace variable N is 2 (NO in step S809), the processing proceeds to step S814. Processing in steps S814 to S817 is similar to the above-described processing, and the description thereof will be omitted. Although not illustrated in FIG. 8, for example, in a case where “Non-Display of Tab Title” is set for “Called Tab” as in Mode 2-3 (the display mode 504) illustrated in FIG. 5A, when the display control unit 315 determines that the intent usage flag is not set to “true” (NO in step S809), the processing proceeds to step S816.

After the completion of the processing in step S817, the display control unit 315 determines whether the processing in steps S804 to S817 is completed for all the pieces of tab transition information acquired in step S800. When the display control unit 315 determines that the processing in steps S804 to S817 is not completed for all the pieces of tab transition information, the display control unit 315 performs the processing in steps S804 to S817 for unprocessed tab transition information. On the other hand, when the display control unit 315 determines that the processing in steps S804 to S817 is completed for all the pieces of tab transition information acquired in step S800, the processing exits this flowchart.

Specific examples of display in each display mode will be described in application examples below.

Next, the processing for checking whether the number of displayed tabs reaches the upper limit to be performed by the MFP 102 according to the present exemplary embodiment will be described with reference to FIG. 9. When receiving a request for acquiring a list of intents that are available when a particular type (e.g. a file type such as “PDF-related” (the type 1901) in specified, the service management unit 321 performs, before acquiring the list from the service search unit 322, the processing for checking whether the number of displayed tabs reaches the upper limit, as illustrated in FIG. 9.

FIG. 9 is a flowchart illustrating the processing for checking whether the number of displayed tabs reaches the upper limit to be performed by the MFP 102 according to the present exemplary embodiment. Each operation of the flowchart illustrated in FIG. 9 is implemented when the CPU 211 of the MFP 102 reads a control program stored in the ROM 212 and then executes it. In the flowchart, reference numerals with the prefix ‘S’ denote steps.

In step S900, the service management unit 321 recognizes the reception of a request for acquiring a list of intents that are available when a particular type (e.g. “PDF-related” (the type 1901)) is specified. Then, the processing proceeds to step S901.

In step S901, the service management unit 321 calls the processing for checking the number of tabs being currently displayed, which is performed by the tab upper limit check unit 319.

In step S902, the tab upper limit check unit 319 acquires the upper limit number of a plurality of displayable tabs stored by the upper limit management unit 320.

In step S903, the tab upper limit check unit 319 acquires all the pieces of tab transition information managed by the tab transition management unit 314.

In step S904, the tab upper limit check unit 319 identifies the number of pieces of tab transition information in which the tab title shading is set to “false”, among the tab transition information acquired in step S903. For example, when the tab transition information as illustrated in FIG. 4B is acquired, the tab upper limit check unit 319 determines that the number of pieces of tab transition information in which the tab title shading is set to “false” is 1.

In step S905, the tab upper limit check unit 319 determines whether the number identified in step S904 is equal to the upper limit number of a plurality of displayable tabs acquired in step S902.

When the tab upper limit check unit 319 determines that the number identified in step S904 is not equal to the upper limit number of a plurality of displayable tabs acquired in step S902 (NO in step S905), the processing exits this flowchart. For example, when the tab transition information as illustrated in FIG. 4B is acquired, the tab upper limit check unit 319 determines that the number identified in step S904 is not equal to the upper limit number (NO in step S905). Then, the processing exits the flowchart as “normal end”.

On the other hand, when the tab upper limit check unit 319 determines that the number identified in step S904 is equal to the upper limit number of a plurality of displayable tabs acquired in step S902 (YES in step S905), the processing proceeds to step S906.

In step S906, the tab upper limit check unit 319 instructs the display control unit 315 to display an error message (e.g. “Upper Limit Number of Displayable Tabs is Reached. Close Unnecessary Tabs.”), and the processing exits this flowchart as “abnormal end”.

When the processing for checking whether the number of displayed tabs reaches the upper limit has “normally ended”, the service management unit 321 calls the service search unit 322 to acquire a list of intents to be managed, and then requests the display control unit 315 of the web browser 310 to display the result of the call. On the other hand, when the processing for checking whether the number of displayed tabs reaches the upper limit has “abnormally ended”, the service management unit 321 stops calling the service search unit 322 to acquire a list of intents to be managed. In this case, a user needs to close unnecessary tabs and then perform an operation for calling an intent again.

### Application Example 1

In an application example 1, the tab transition information registration processing to be performed in response to recognition of a received response will be described below. The display mode is assumed to be not set in the application example 1.

[Case 1] an Intent is Used with a Response of the Caller Tab

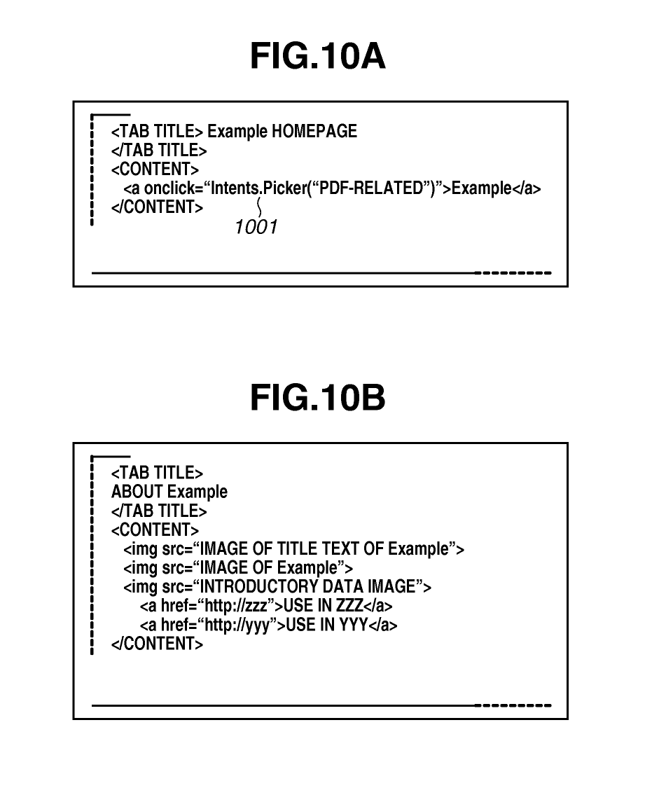

In case 1, in step S600, the reception unit 312 recognizes a response received from the server 101 (e.g. a received response illustrated in FIG. 10A).

FIG. 10A illustrates an example of a received response.

In step S604, the tab provision unit 313 recognizes that a definition for calling intent (specification 1001 illustrated in FIG. 10A) is included in the received response, and the processing proceeds to step S605.

In step S607, the tab provision unit 313 acquires the tab transition information. It is assumed here that the tab provision unit 313 acquires no tab transition information. The tab provision unit 313 determines that no tab transition information is acquired (NO in step S608), and the processing proceeds to step S617.

In step S618, the tab provision unit 313 requests the tab transition management unit 314 to register the tab transition information of the workspace variable. At this request, for example, the tab transition information illustrated in FIG. 4A is registered in the tab transition information management table. After requesting the registration of the tab transition information, the tab provision unit 313 requests the display control unit 315 to display the tab transition information.

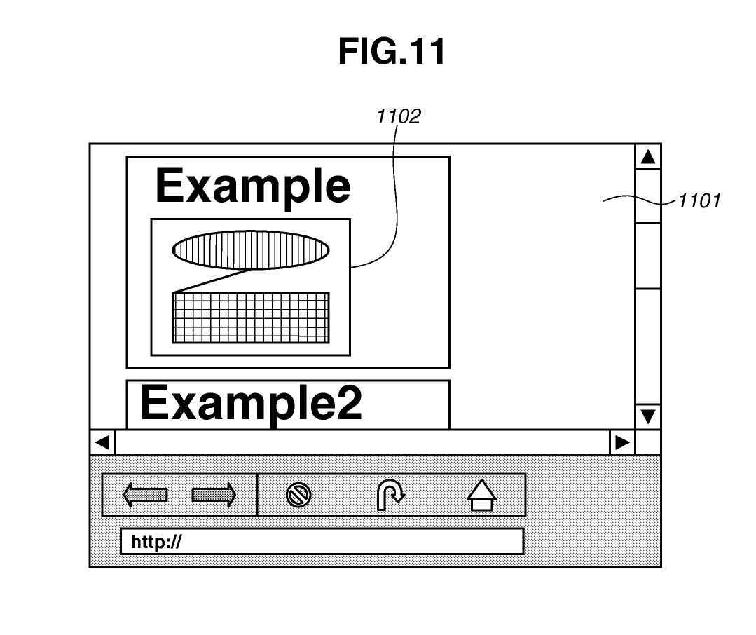

FIG. 11 illustrates an example of a screen displayed by the display control unit 315 in response to reception of a request for displaying the tab transition information in case 1 according to the application example 1.

FIG. 4A illustrates one piece of tab transition information. The display control unit 315 omits display of the tab title, and displays, in a content area 1101 (illustrated in FIG. 11), content 401 in the content.

Processing for calling an intent in the content area 1101 via a user's operation will be described below.

When the user clicks an “Example” image 1102 in the content area 1101, the service management unit 321 recognizes “Intents.Picker (“PDF-related”)”, i.e., the specification 1001 illustrated in FIG. 10A, which is the action to be taken in response to a click. The action recognized by the service management unit 321 is the reception of an intent list acquisition request with specification of a particular type (“PDF-related”). As described above, the service management unit 321 specifies the particular type (“PDF-related”) to acquire from the service search unit 322 a result of a search for data corresponding to the particular type, and provides the acquired list of available intents to the display control unit 315.

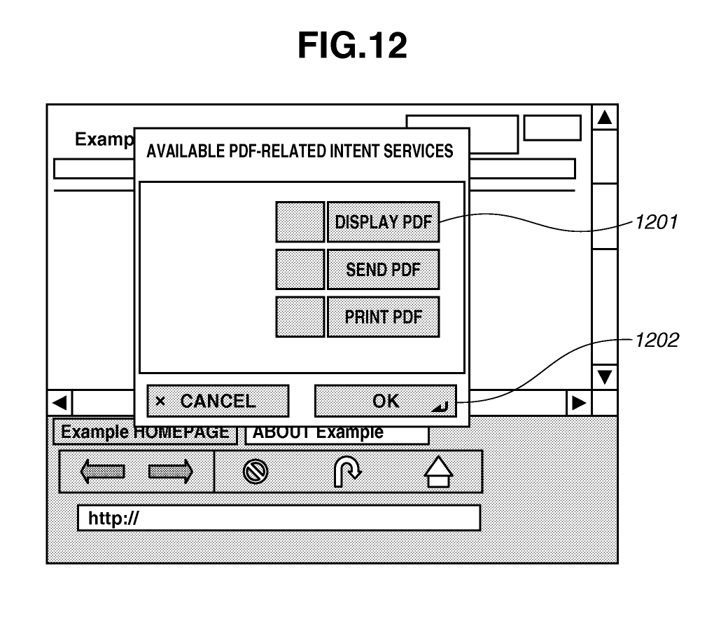

FIG. 12 illustrates an example of a panel display of an intent list.

According to the application example 1, since the types of all pieces of information illustrated in FIG. 19 is “PDF-related”, the display control unit 315 displays a list of all the pieces of tab transition information. The user selects a specific intent from the list of available intents (for example, the user selects a “Display PDF” (an intent 1201) and then presses an OK button 1202) to call the intent.

The access destination of the intent called by the above-described selection is a setting value in “End Point” 1902 illustrated in FIG. 19. In this case, since a parameter (disposition=“window”) 1903 indicating a new tab is specified, the service management unit 321 recognizes that the selected intent is a request for opening a new tab.

[Case 2] an Intent is Called from the Caller Tab in Case 1, and a Response of a New Tab is Received

In case 2, in step S600 illustrated in FIG. 6, the reception unit 312 recognizes a response received from the server 101 (e.g. a received response illustrated in FIG. 10B).

FIG. 10B illustrates an example of a received response.

In step S604, the tab provision unit 313 determines that the received response does not include the definition (NO in step S604). Then, the processing proceeds to step S606.

In step S606, the tab provision unit 313 sets the new tab flag of the tab transition information in the workspace variable to “true”.

In step S607, the tab provision unit 313 acquires the tab transition information. In this case, the tab transition information as illustrated in FIG. 4A is acquired, and the tab provision unit 313 determines that one piece of tab transition information is acquired. The tab provision unit 313 determines that one or more pieces of tab transition information are acquired in step S607 (YES in step S608). Then, the processing proceeds to step S609.

In step S609, the tab provision unit 313 identifies the tab transition information having the largest tab number (in this case, the tab transition information of “Tab No. 1”) in the tab transition information acquired in step S607.

In step S610, the tab provision unit 313 determines that the new tab flag of the tab transition information in the workspace variable is set to “true” (YES in step S610). Then, the processing proceeds to step S611.

In step S611, the tab provision unit 313 determines that the intent usage flag of the tab transition information having the largest tab number identified in step S609 (the tab transition information of “Tab No. 1” illustrated in FIG. 4A) is set to “true” (YES in step S611). Then, the processing proceeds to step S612.

In step S612, the tab provision unit 313 sets the tab title shading of the tab transition information having the largest tab number (“Tab No. 1”) identified in step S609 to “true”, and requests the tab transition management unit 314 to update the identified tab transition information having the largest tab number. In this update processing, since the data of “Tab No. 1” (402) illustrated in FIG. 4B is update target data, the tab provision unit 313 updates the tab title shading to “true” (403).

In step S618, the tab provision unit 313 requests the tab transition management unit 314 to register the tab transition information of the workspace variable. At this registration request, for example, the tab transition information of “Tab No. 2” (404) illustrated in FIG. 4B is registered in the tab transition information management table.

After registering the tab transition information, the tab provision unit 313 requests the display control unit 315 to display the tab transition information.

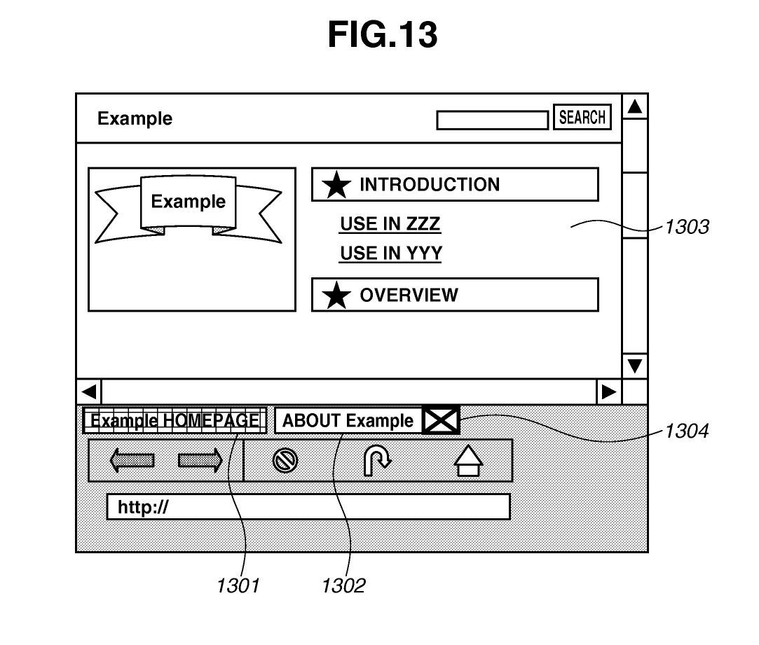

FIG. 13 illustrates an example of a screen displayed in case 2 according to the application example 1.

FIG. 4B illustrates two pieces of tab transition information. The display control unit 315 displays the tab transition information in the order of tab number.

First of all, based on the tab transition information of “Tab No. 1” (402), the display control unit 315 displays, in a tab title area 1301, a tab title 405 in the content, as illustrated in FIG. 13. Since the tab title shading is set to “true” (403) in the tab transition information of “Tab No. 1” (402), in step S815 illustrated in FIG. 8, the display control unit 315 displays the tab title area 1301 in a disabled state (for example, the tab title 405 is displayed with shading so that it does not react when pressed). In step S816, the display control unit 315 further displays, in a tab content area (not illustrated), content 410 in the content.

Then, based on the tab transition information of “Tab No. 2” (404), the display control unit 315 displays, in a second tab title area 1302, a tab title 406 in the content. Since the tab title shading is set to “false” (407) in the tab transition information of “Tab No. 2” (404), the display control unit 315 displays the tab title 406 which can be pressed (in step S814 illustrated in FIG. 8). Since the close button is set to “displayed” in the tab transition information of “Tab No. 2” (404), the display control unit 315 displays a close button 1304. In step S816, the display control unit 315 further displays, in a second tab content area 1303, content 408 in the content.

As described above, while a new tab is displayed via an intent call, the display control unit 315 displays the tab title of the caller tab with shading (i.e. in a mode where an instruction for switching the operation target tab cannot be received) to prevent a tab transition to the caller tab. This configuration can prevent the caller tab from repeatedly calling an intent, making it easier to prevent the number of tabs from reaching an upper limit on the number of a plurality of displayable tabs, resulting in improving user's convenience.

When recognizing a press of the close button 1304, the tab provision unit 313 performs the close button press processing as illustrated in FIG. 7.

### Application Example 2

In an application example 2, the display mode switching processing to be performed after recognition of a request for displaying the tab transition information issued by the tab provision unit 313 will be described below.

In the application example 2, respective cases where Mode 2-1, Mode 2-2, and Mode 2-3 are selected as the display mode in a case where the response in case 2 according to the application example 1 is received will be described below. Setting values for changing the display mode can be set in the tab display mode management table managed by the tab display management unit 318.

In the tab display mode management table illustrated in FIG. 5A, the setting values in the row selected in the “Select” column 500 are enabled. Among the display modes, a case where Mode 1 (the display mode 501) is selected is similar to the above-described case according to the application example 1 where the display mode is not set, and the description thereof will be omitted.

First of all, a case where Mode 2-1 (the display mode 502) is selected will be described below.

In step S802 illustrated in FIG. 8, the display control unit 315 initializes the workspace variable N to “1”. In steps S803 to S818, the display control unit 315 starts the processing for “Tab No. 1” (402) illustrated in FIG. 4B. In step S805, the display control unit 315 determines that the setting values of the selected display mode 502 exist in the tab display mode management table managed by the tab management unit 318 (YES in step S805). Then, the processing proceeds to step S806. In step S807, the display control unit 315 determines that “Tab Title Shading” for “Caller Tab” in the setting values of the selected display mode 502 is set to not “true” (O) (NO in step S807), and the processing proceeds to step S809.

In step S809, the display control unit 315 determines that the intent usage flag in the tab transition information of “Tab No. 1” is set to “true” (YES in step S809). Then, the processing proceeds to step S811. In step S811, the display control unit 315 determines that “Arrow Display” for “Caller Tab” in the setting values of the selected display mode 502 is set to not “true” (O) (NO in step S811), and the processing proceeds to step S817.

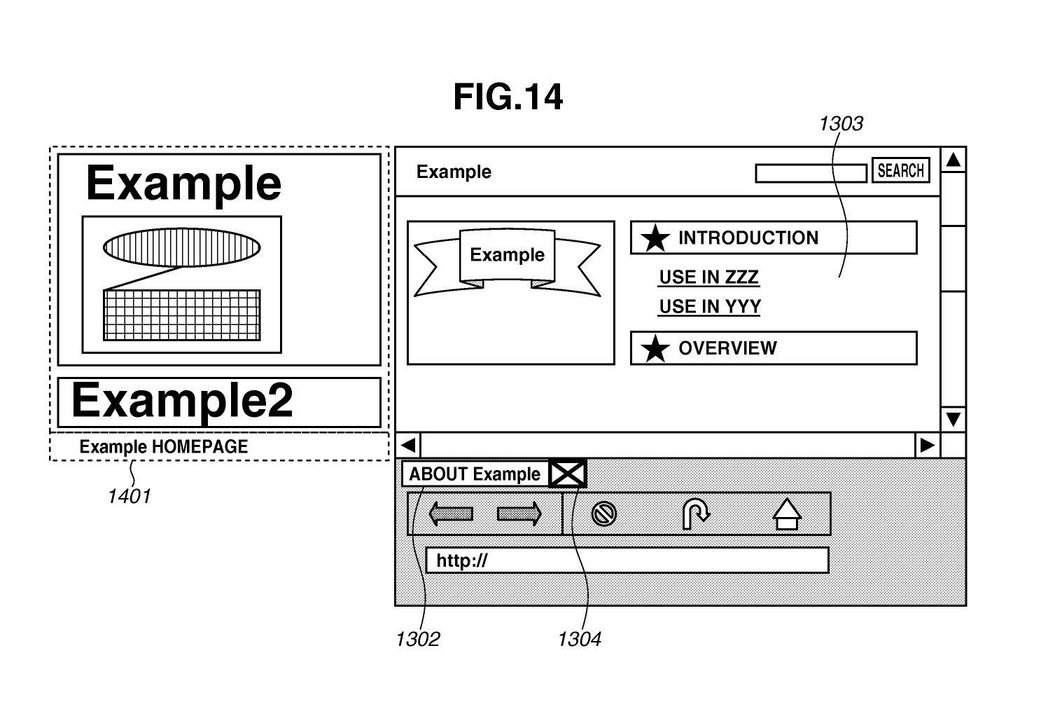

FIG. 14 illustrates an example of a screen displayed when Mode 2-1 is selected according to the application example. Elements illustrated in FIG. 14 similar to those illustrated in FIG. 13 are assigned the same reference numerals. In this example, as illustrated in a dotted box 1401 in FIG. 14, the content corresponding to the tab transition information of “Tab No. 1” (402) is not displayed. The tab title corresponding to the tab transition information of “Tab No. 1” (402) is not displayed, either.

In step S817, the display control unit 315 increments the workspace variable N by 1, and starts the processing for the following “Tab No. 2” (404).

In step S809, the display control unit 315 determines that the intent usage flag in the tab transition information of “Tab No. 2” is set to “false” (409) (NO in step S809). Then, the processing proceeds to step S814. In step S814, the display control unit 315 sets, in the second tab title area 1302 illustrated in FIG. 14, the tab title of the specific tab transition information. Since the close button is set to “displayed” in the tab transition information of “Tab No. 2” (404), the display control unit 315 displays the close button 1304 illustrated in FIG. 14. In step S816, the display control unit 315 sets, in the second tab content area 1303, the content of the specific tab transition information. In step S817, the display control unit 315 increments the workspace variable N by 1, and ends the loop (steps S803 to S818). Then, the processing exits the flowchart of the display mode switching processing.

A case where Mode 2-2 (the display mode 503) is selected will be described below.

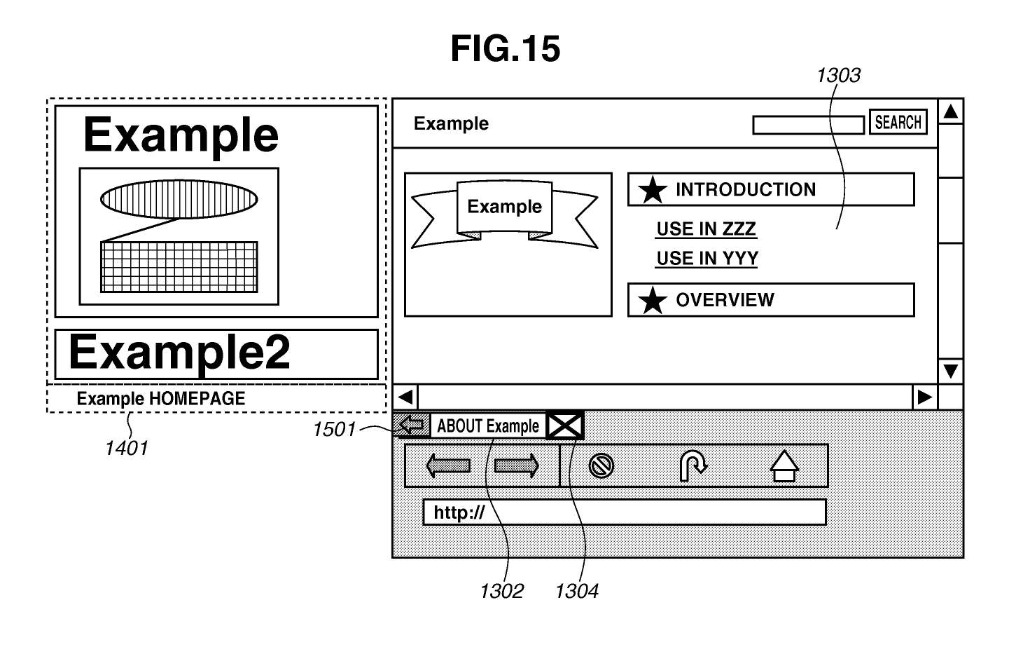

In the case of Mode 2-2 (the display mode 503), the display control unit 315 performs similar processing to the processing to be performed in the case of Mode 2-1 (the display mode 502), and the processing proceeds to step S811. In step S811, the display control unit 315 determines that “Arrow Display” for “Caller Tab” in the setting values of the selected display mode 503 is set to “true” (O) (YES in step S811). Then, the processing proceeds to step S812. In step S812, the display control unit 315 sets, in the arrow display area, specification for displaying the content of the caller tab of the tab transition information of “Tab No. 1” in response to a press of an arrow 1501 illustrated in FIG. 15.

FIG. 15 illustrates an example of a screen displayed when Mode 2-2 is selected according to the application example 2. Elements illustrated in FIG. 15 similar to those illustrated in FIG. 14 are assigned the same reference numerals. Also in the case of Mode 2-2, similarly to Mode 2-1, the content corresponding to the tab transition information of “Tab No. 1” (402) is not displayed, as illustrated in the dotted box 1401 in FIG. 15. Further, the tab title 405 corresponding to the tab transition information of “Tab No. 1” (402) is not displayed, either. However, in the case of Mode 2-2, the arrow 1501 for indicating that the content corresponding to the tab transition information of “Tab No. 1” (402) exists is displayed.

In step S817, the display control unit 315 increments the workspace variable N by 1, and starts the processing of the next “Tab No. 2” (404). The processing for “Tab No. 2” (404) is similar to the processing for Mode 2-1 (the display mode 502), and the descriptions thereof will be omitted.

A case where Mode 2-3 (the display mode 504) is selected will be described below.

In the case of Mode 2-3 (the display mode 504), the processing for “Tab No. 1” (402) is similar to the processing for Mode 2-1 (the display mode 502), and the description thereof will be omitted.

The processing for “Tab No. 2” (404) will be described below.

In the processing for “Tab No. 2” (404), similarly to Mode 2-1 (the display mode 502), the processing proceeds to step S809. However, in the case of Mode 2-3 (the display mode 504), when the intent usage flag in the tab transition information of “Tab No. 2” is determined to be “false” (NO in step S809), the processing proceeds to step S816. In step S816, the display control unit 315 sets the content of the tab transition information of “Tab No. 2” (404) in the second tab content area 1303. In step S817, the display control unit 315 increments the workspace variable N by 1, and the processing exits the loop.

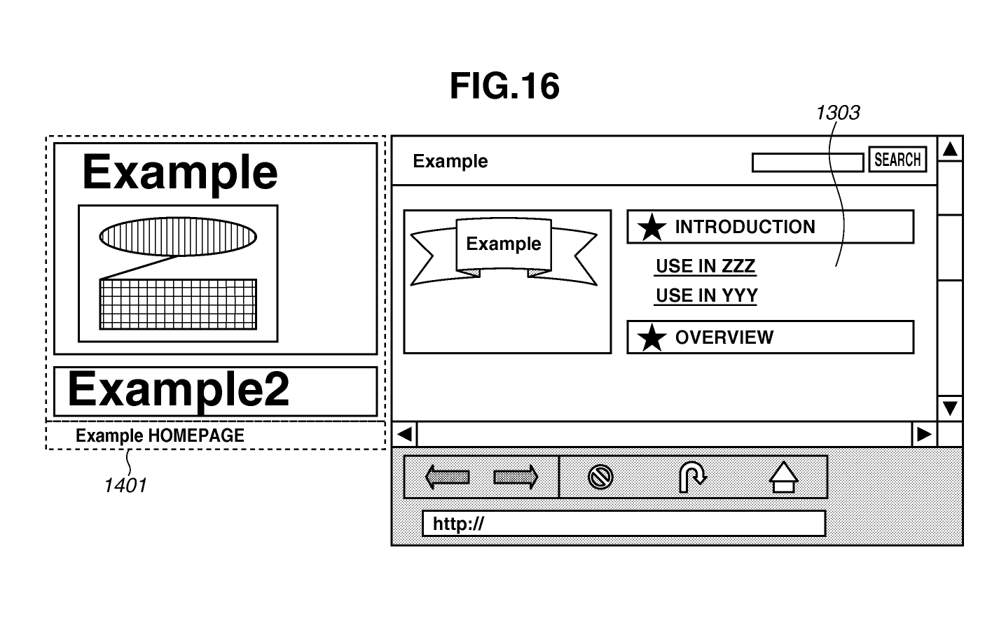

FIG. 16 illustrates an example of a screen displayed when Mode 2-3 is selected according to the application example 2. Elements illustrated in FIG. 15 similar to those illustrated in FIG. 14 are assigned the same reference numerals. Also in the case of Mode 2-3, similarly to Mode 2-1, the content corresponding to the tab transition information of “Tab No. 1” (402) is not displayed, as illustrated in the dotted box 1401 in FIG. 16. Further, the title corresponding to the tab transition information of “Tab No. 1” (402) is not displayed, either. In the case of Mode 2-3, the tab title 406 and the close button corresponding to the tab transition information of “Tab No. 2” (404) are not displayed, either.

As described above, while a new tab is displayed via an intent call, the tab title of the caller tab is displayed with shading (the switching disabled) to prevent a tab transition to the caller tab. This configuration can prevent the caller tab from repeatedly calling an intent, making it easier to prevent the number of tabs from reaching the upper limit number of a plurality of displayable tabs. In addition, switching the display mode settings for the caller or called tab can improve usability, resulting in improving user's convenience.

As described above, when the display mode is not set or is Mode 1 (the display mode 501), while a new tab called via an intent is displayed, displaying the tab title of the caller tab with shading (i.e., in a mode where an instruction for switching the operation target tab cannot be received) can restrict the operation target from being switched back to the caller tab.

When the display mode is any one of Mode 2-1 (the display mode 502), Mode 2-2 (the display mode 503), and Mode 2-3 (the display mode 504), while a new tab called via an intent is displayed, hiding the caller tab (and the tab title of the caller tab) can restrict the operation target from being switched back to the caller tab.

### Application Example 3

In an application example 3, the processing for checking whether the number of displayed tabs reaches the upper limit to be performed when the service management unit 321 recognizes the reception of a request for acquiring a list of intents that are available when a particular type (“PDF-related”) is specified will be described.

The application example 3 applies to a case where the number of pieces of tab transition information, which is the same as the upper limit number of displayable tabs (505 (illustrated in FIG. 5) have already been registered, and all the pieces of tab transition information are currently displayed as tabs. Further, in this case, the content of a currently displayed tab is selected, an intent list acquisition request is recognized, and then the processing for checking whether the number of displayed tabs reaches the upper limit is started.

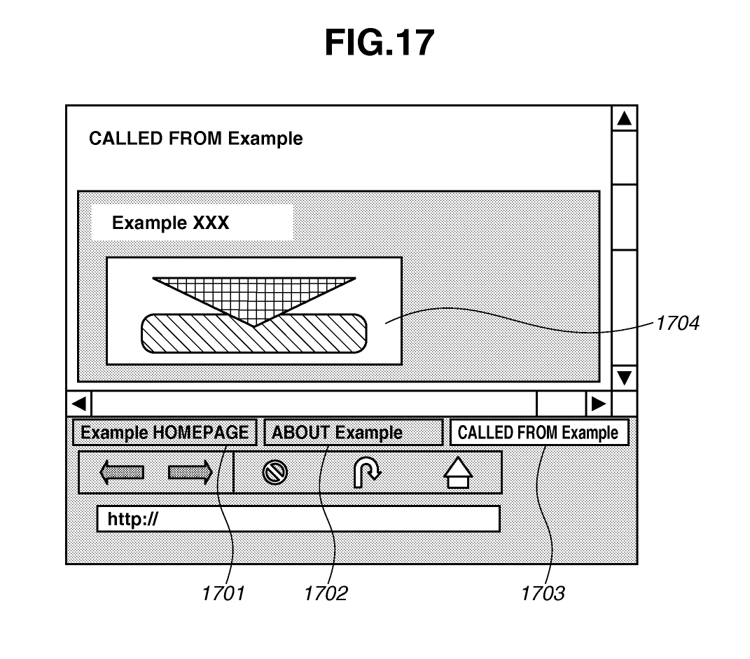

FIG. 17 illustrates an example of a screen displayed in a case according to the application example 3.

As illustrated in FIG. 17, the upper limit number of tabs, i.e., three tabs 1701, 1702, and 1703 are displayed. When content 1704 on the tab 1703 is selected in this state, a particular type (e.g. a file type such as “PDF-related” (the type 1901)) is specified. Then, the service management unit 321 recognizes an intent list acquisition request and starts the processing for checking whether the number of displayed tabs reaches the upper limit.

In step S900, the service management unit 321 recognizes the reception of a request for acquiring a list of intents that are available when a particular type (“PDF-related”) is specified. In step S901, the service management unit 321 calls the processing for checking whether the number of displayed tabs reaches the upper limit, which is performed by the tab upper limit check unit 319. In step S902, the tab upper limit check unit 319 acquires the upper limit number of a plurality of displayable tabs (i.e. 3) stored by the upper limit management unit 320. In step S904, the tab upper limit check unit 319 identifies the number of pieces of tab transition information in which the tab title shading is set to “false”, among the tab transition information acquired in step S903. In the present exemplary embodiment, the tab upper limit check unit 319 identifies the three tabs 1701, 1702, and 1703.

In step S905, the tab upper limit check unit 319 determines that the number identified in step S904 is equal to the upper limit number of a plurality of displayable tabs (i.e. 3) acquired in step S902 (YES in step S905). Then, the processing proceeds to step S906. In step S906, the tab upper limit check unit 319 instructs the display control unit 315 to display an error message (e.g. “Upper Limit Number of Displayable Tabs is Reached. Web Sites Corresponding to Specified Intent Information Cannot Be Displayed by Using Tabs. Close Unnecessary Tabs.”) to warn and prompt the user to close tabs.

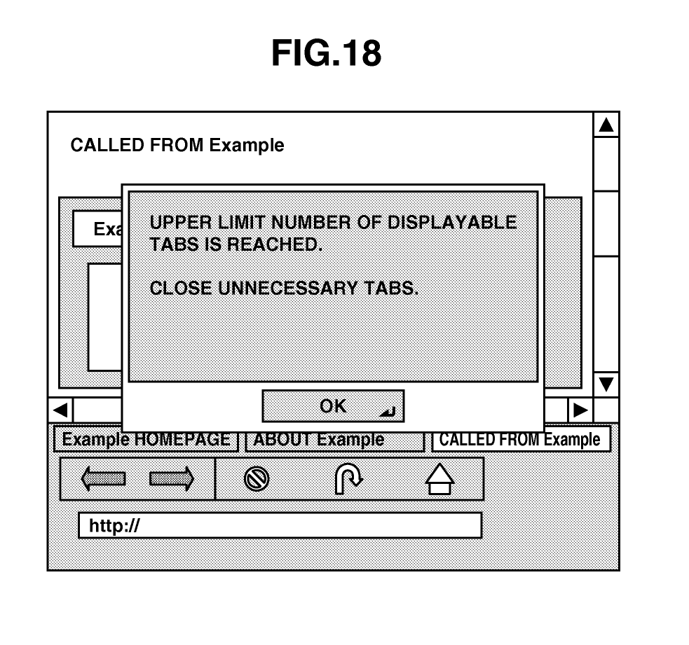

FIG. 18 illustrates an example of an error message (warning) displayed by the display control unit 315.

As described above, before providing a list of intents available via an intent, the tab upper limit check unit 319 checks the upper limit number of a plurality of displayable tabs. When the upper limit number of displayable tabs is reached, the display control unit 315 displays an error message to prevent the number of displayed tabs from reaching an upper limit on the number of a plurality of displayable tabs, resulting in improving user's convenience.

According to the present exemplary embodiment, it is possible to prevent, while a tab called via an intent is open, another tab from being called from the caller tab via an intent. This prevents the number of tabs displayed on a web browser from easily reaching an upper limit, thus improving user's convenience. For example, the present exemplary embodiment is effective particularly in a case where an apparatus having a low upper limit on the number of displayable tabs due to insufficient resources cooperates with a web application.

While the present exemplary embodiment has been described based on the above-described various data configurations and contents, the present exemplary embodiment is not limited thereto. Diverse data configurations and contents are applicable according to applications and purposes.

The above-described exemplary embodiment can be implemented by, for example, a system, an apparatus, a mode, a program, or a storage medium. More specifically, the above-described exemplary embodiment is applicable to a system including a plurality of apparatuses and to an apparatus including a single device.

Further, all the combinations of the configurations according to the above-described exemplary embodiment are included in the present invention.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-232001, filed Nov. 14, 2014, which is hereby incorporated by reference herein in its entirety.

What is claimed is:

1. An information processing apparatus having a web browser operating thereon to enable browsing of web sites by using a plurality of tabs, the information processing apparatus comprising:
a management unit configured to manage, in a storage device, intent information corresponding to a web application;
a reception unit configured to receive specification of the intent information via the web browser;
a storage unit configured to store, in a case where the intent information is specified via the web browser while a first site is being browsed using a first tab, information related to the first tab; and
a display control unit configured to display, using a second tab, a second site corresponding to the specified intent information via the web browser,
wherein, until the second tab is closed, the web browser restricts an operation on the first site using the first tab related to the stored information.

2. The information processing apparatus according to claim 1, wherein, until the second tab is closed, the web browser restricts the operation on the first site using the first tab related to the stored information by restricting switching of an operation target to the first tab.

3. The information processing apparatus according to claim 2, wherein, until the second tab is closed, the web browser restricts the switching to the first tab by displaying an instruction portion for issuing an instruction to switch the operation target to the first tab in a mode where the issuing of the instruction is disabled, or by not displaying the instruction portion.

4. The information processing apparatus according to claim 1, wherein, until the second tab is closed, the web browser restricts, by not displaying the first tab, the operation on the first site using the first tab related to the stored information.

5. An information processing apparatus having a web browser operating thereon to enable browsing of web sites by using a plurality of tabs, the information processing apparatus comprising:
a management unit configured to manage, in a storage device, intent information corresponding to a web application;
a reception unit configured to receive specification of the intent information via the web browser; and
a display control unit configured to display, using a second tab, a second site corresponding to the specified intent information via the web browser,
wherein, according to an upper limit number of tabs on the web browser, the display control unit performs control to display a warning indicating that a site corresponding to the specified intent information is not displayable by using a tab.

6. A method for controlling an information processing apparatus having a web browser operating thereon to enable browsing of web sites by using a plurality of tabs, and including a management unit configured to manage intent information corresponding to a web application, the method comprising:
receiving specification of the intent information via the web browser;
storing, in a case where the intent information is specified via the web browser while a first site is being browsed using a first tab, information related to the first tab;
displaying, using a second tab, a second site corresponding to the specified intent information via the web browser; and
restricting, on the web browser, an operation on the first site using the first tab related to the stored information until the second tab is closed.

7. A method for controlling an information processing apparatus having a web browser operating thereon to enable browsing of web sites by using a plurality of tabs, and including a management unit configured to manage intent information corresponding to a web application, the method comprising:
receiving specification of the intent information via the web browser;
displaying, using a second tab, a second site corresponding to the specified intent information via the web browser; and
performing, according to an upper limit number of tabs on the web browser, control to display a warning indicating that a site corresponding to the specified intent information is not displayable by using a tab.

8. A non-transitory computer-readable storage medium for storing a program for causing a computer to execute a method for controlling an information processing apparatus having a web browser operating thereon to enable browsing of web sites by using a plurality of tabs, and including a management unit configured to manage intent information corresponding to a web application, the method comprising:
receiving specification of the intent information via the web browser;
storing, in a case where the intent information is specified via the web browser while a first site is being browsed using a first tab, information related to the first tab;
displaying, using a second tab, a second site corresponding to the specified intent information via the web browser; and
restricting, on the web browser, an operation on the first site using the first tab related to the stored information until the second tab is closed.

9. A non-transitory computer-readable storage medium for storing a program for causing a computer to execute a method for controlling an information processing apparatus having a web browser operating thereon to enable browsing of web sites by using a plurality of tabs, and including a management unit configured to manage intent information corresponding to a web application, the method comprising:
receiving specification of the intent information via the web browser;
displaying, using a second tab, a second site corresponding to the specified intent information via the web browser; and
performing, according to an upper limit number of tabs on the web browser, control to display a warning indicating that a site corresponding to the specified intent information is not displayable by using a tab.
